(19) United States
(12) Patent Application Publication
(10) Pub. No.: US 2012/0123769 A1
(43) Pub. Date: May 17, 2012

(54) GAIN CONTROL APPARATUS AND GAIN CONTROL METHOD, AND VOICE OUTPUT APPARATUS

(75) Inventor: Shigefumi Urata, Osaka-shi (JP)

(73) Assignee: SHARP KABUSHIKI KAISHA, Osaka-shi, Osaka (JP)

(21) Appl. No.: 13/319,980

(22) PCT Filed: May 13, 2010
(86) PCT No.: PCT/JP2010/003245

§ 371 Date: Jan. 30, 2012

(30) Foreign Application Priority Data
May 14, 2009 (JP) 2009-117702

(51) Int. Cl. G10L 19/14

(52) U.S. Cl. 704/225; 704/E19.039

(57) ABSTRACT

Provided is a technology which adjusts an input signal such that the volume of a conversation or speech contained in a content is substantially constant, thereby alleviating the audience from a burden of making a volume control operation. An acoustic signal processor comprises an acoustic signal storage unit which buffers an acoustic input signal for a predetermined period of time; a voice detection unit which detects a voice section from the buffered acoustic signal; an acoustic signal-to-loudness level transformation which calculates a loudness level from the buffered acoustic signal; a threshold/level comparator which compares the calculated loudness level with a predetermined target level; a voice amplification calculation unit which calculates a gain control amount for the buffered acoustic signal on the basis of the detection and comparison results; and an acoustic signal amplifier which amplifies or dampens the buffered acoustic signal in accordance with the calculated gain control amount.

### TECHNICAL FIELD

The present invention relates to a gain control apparatus and gain control method, and a voice output apparatus, and more particularly relates to a gain control apparatus and gain control method, and a voice output apparatus for performing an amplification process when an acoustic signal includes a voice signal.

### BACKGROUND ART

When audience views a content containing a speech or conversation on a TV set or the like, the audience often adjusts the sound volume to a level which allows easy listening the speech or conversation. However, with the content being changed over, the level of the voice recorded will be changed. In addition, even in the same content, depending upon the gender, age, voice quality, and the like, of a talker, the feeling of sound volume of a speech or conversation actually heard varies, thereby, every time the speech or conversation becomes difficult to be heard, the audience will feel the need for adjusting the sound volume.

In such a background, in order to make the speech or conversation in a content easier to be heard, various technologies have been proposed. For example, there is disclosed a technology which extracts a voice band signal from an input signal and modifies it by AGC (Patent Document 1 referenced). This technology divides an input signal into bands by using a voice band BPF for generating voice band signals. Further, it detects a maximum amplitude value for the respective voice band signals within a definite period of time, and by performing amplitude control according thereto, creates a voice band emphasized signal. And, it adds a signal obtained by performing AGC compression processing to the input signal, to a signal obtained by performing AGC compression processing to the voice band emphasized signal, thereby producing an output signal.

In addition, as another technology, there is disclosed an invention which uses a voice signal output of a TV set as an input; detects a segment section of an actual voice of a human in the input signal; and emphasizes the consonant in the signal for the section, thereby outputting it (Patent Document 2 referenced).

In addition, there is disclosed a technology which, from an input signal, extracts a signal containing frequency information based on the audibility of a human, and smoothes it; transforms the smoothed signal into an auditory sound volume signal, which represents the degree of sound volume that a human bodily senses; and controls the amplitude of the input signal such that it approaches the volume value which has been set (Patent Document 3 referenced).

### Citation List

### Patent Documents

Patent Document 1: Japanese Unexamined Patent Application Publication No. 2008-89982

Patent Document 2: Japanese Unexamined Patent Application Publication No. Hei8-275087

Patent Document 3: Japanese Unexamined Patent Application Publication No. 2004-318164

### DISCLOSURE OF THE INVENTION

### Problems to be Solved by the Invention

With the technology as disclosed in Patent Document 1, there is a problem that the maximum amplitude value does not always match the sound volume which audience actually senses, thereby it is extremely difficult to make an effective emphasis.

With the technology as disclosed in Patent Document 2, because the degree of emphasis of the consonant is constant, there is a problem that the consonant is emphasized independently of the gender and voice quality of the talker, thereby the original tone quality and voice quality being easily impaired. Further, there is another problem that the sound volume of the talker varies depending upon the content inputted, and thus when the sound volume is absolutely small, it is difficult to improve the articulation, even if the consonant is emphasized. Still further, a specific method of detecting a segment section of voice is not disclosed, and thus it is difficult to introduce this technology, thereby another technology has been demanded.

With the technology as disclosed in Patent Document 3, there is a problem that, during the entire period of reproduction output, the input signal is brought close to the set volume value, and thus there is a possibility that the feeling of dynamic range for a content, such as a movie, or the like, may be greatly impaired.

In view of the aforementioned problems, the present invention has been made to provide a technology which adjusts an input signal such that the volume of a conversation or speech contained in a content is substantially constant, thereby alleviating the audience from a burden of making a volume control operation.

### Means for Solving the Problems

An apparatus according to the present invention relates to a gain control apparatus. This apparatus comprises: a voice detection unit which detects a voice section from an acoustic signal; an acoustic signal-to-loudness level transformation unit which calculates a loudness level, which is a volume level actually perceived by a human, for the acoustic signal; a level comparison unit which compares the calculated loudness level with a predetermined target level; an amplification amount calculation unit which calculates a gain control amount for the acoustic signal on the basis of the detection result by the voice detection unit and the comparison result by the level comparison unit; and a voice amplification unit which makes a gain adjustment of the acoustic signal in accordance with the gain control amount calculated.

The acoustic signal-to-loudness level transformation unit may calculate a loudness level, upon the voice detection unit having detected a voice section.

The acoustic signal-to-loudness level transformation unit may calculate a loudness level by the frame which is constituted by a predetermined number of samples.

The acoustic signal-to-loudness level transformation unit may calculate a loudness level by the phrase, which is a unit of voice section.

The acoustic signal-to-loudness level transformation unit may calculate a peak value of loudness level by the phrase, and the level comparison unit may compare the peak value of loudness level with the predetermined target level.

Upon the peak value of loudness level in the current phrase exceeding the peak value of loudness level in the previous phrase, the level comparison unit may compare the peak value of loudness level in the current phrase with the predetermined target level, and upon the peak value of loudness level in the current phrase being not more than the peak value of loudness level in the previous phrase, the level comparison unit may compare the peak value of loudness level in the previous phrase with the predetermined target level.

The voice detection unit may comprise a fundamental frequency extraction unit which extracts a fundamental frequency from the acoustic signal for each frame; a fundamental frequency change detection unit which detects a change of the fundamental frequency in a predetermined number of plural frames which are consecutive; and a voice judgment unit which judges the acoustic signal to be a voice, upon the fundamental frequency change detection unit detecting that the fundamental frequency is monotonously changed, or is changed from a monotonous change to a constant frequency, or is changed from a constant frequency to a monotonous change, the fundamental frequency being changed within a predetermined range of frequency, and the span of change of the fundamental frequency being smaller than a predetermined span of frequency.

The method according to the present invention relates to a gain control method. The method comprises: a voice detection step of detecting a voice section from an acoustic signal buffered for a predetermined period of time; an acoustic signal-to-loudness level transformation step of calculating a loudness level, which is a volume level actually perceived by a human, from the acoustic signal; a level comparison step of comparing the calculated loudness level with a predetermined target level; an amplification amount calculation step of calculating a gain control amount for the acoustic signal being buffered, on the basis of the detection result by the voice detection step and the comparison result by the level comparison step; and a voice amplification unit which performs a gain adjustment to the acoustic signal in accordance with the gain control amount calculated.

The acoustic signal-to-loudness level transformation step may calculate a loudness level, upon the voice detection step having detected a voice section.

The acoustic signal-to-loudness level transformation step may calculate a loudness level by the frame which is constituted by a predetermined number of samples.

The acoustic signal-to-loudness level transformation step may calculate a loudness level by the phrase, which is a unit of voice section.

The acoustic signal-to-loudness level transformation step may calculate a peak value of loudness level by the phrase, and the level comparison step may compare the peak value of loudness level with the predetermined target level.

The level comparison step may compare the peak value of loudness level in the current phrase with the predetermined target level, upon the peak value of loudness level of the current phrase exceeding the peak value of loudness level in the previous phrase, and may compare the peak value of loudness level in the previous phrase with the predetermined target level, upon the peak value of loudness level in the current phrase being not more than the peak value of loudness level in the previous phrase.

The voice detection step may comprise a fundamental frequency extraction step of extracting a fundamental frequency from the acoustic signal for each frame; a fundamental frequency change detection step of detecting a change of the fundamental frequency in a predetermined number of plural frames which are consecutive; and a voice judgment step of judging the acoustic signal to be a voice, upon the fundamental frequency change detection step detecting that the fundamental frequency is monotonously changed, or is changed from a monotonous change to a constant frequency, or is changed from a constant frequency to a monotonous change, the fundamental frequency being changed within a predetermined range of frequency, and the span of change of the fundamental frequency being smaller than a predetermined span of frequency.

Another voice output apparatus according to the present invention comprises the aforementioned gain control apparatus.

### ADVANTAGES OF THE INVENTION

According to the present invention, a technology can be provided which adjusts an input signal such that the volume of a conversation or speech contained in a content is substantially constant, thereby alleviating the audience from a burden of making a volume control operation.

### BRIEF DESCRIPTION OF THE DRAWINGS

FIG. 1 is a function block diagram illustrating a schematic configuration of an acoustic signal processor according to an embodiment;

FIG. 2 is a function block diagram illustrating a schematic configuration of a voice detection unit according to the embodiment;

FIG. 3 is a flow chart illustrating the operation of the acoustic signal processor according to the embodiment;

FIG. 4 is a flow chart illustrating the operation of the acoustic signal processor according to a first modification; and

FIG. 5 is a flow chart illustrating the operation of the acoustic signal processor according to a second modification.

### BEST MODE FOR CARRYING OUT THE INVENTION

Next, an embodiment of the present invention (hereinbelow referred to as an embodiment) will be specifically explained with reference to the drawings. The outline of the embodiment is as follows. From an input signal given in one or more channels, a speech or conversation section is detected. In the present embodiment, a signal containing data of human voice or any other sound is referred to as an acoustic signal, and a sound which comes under the category of human voice uttered as a speech, conversation, or the like, is referred to as a voice. Further, an acoustic signal which belongs to the region of voice is referred to as a voice signal. Next, the loudness level of the acoustic signal in the detected section is calculated, and the amplitude of the signal in the detected section (or the adjacent section) is controlled such that the level approaches the predetermined target level. In this way, the sound volume of the speech or conversation is made constant in all contents, thereby the audience can always catch the content of the speech or conversation more clearly with no need for making a volume control operation. Hereinbelow, there will be a specific explanation.

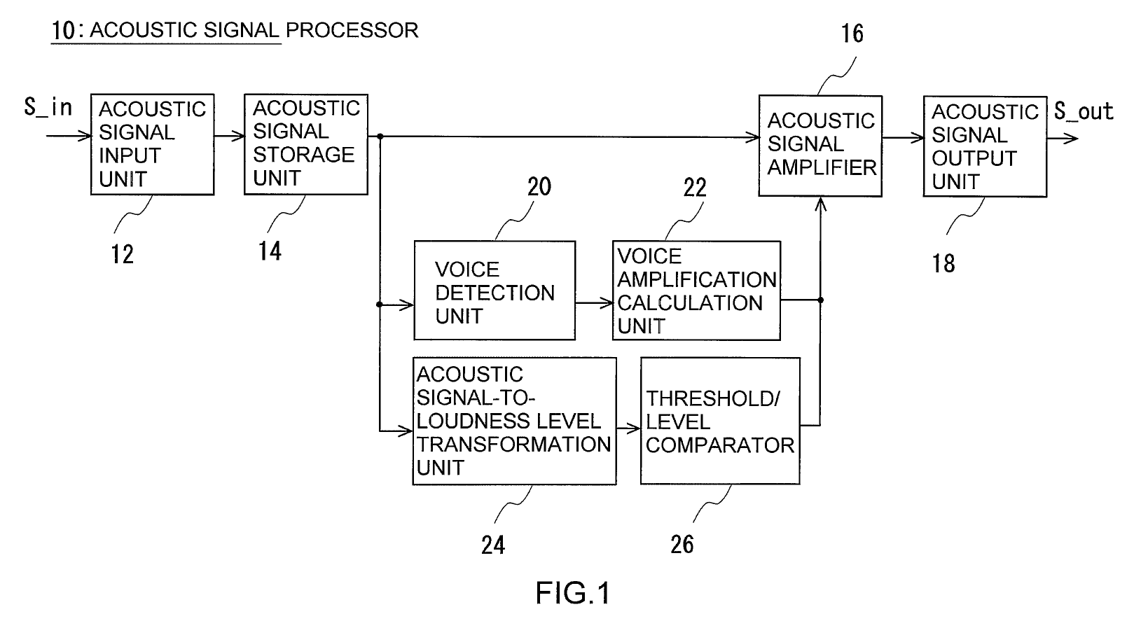

FIG. 1 is a function block diagram illustrating a schematic configuration of an acoustic signal processor 10 according to the present embodiment. This acoustic signal processor 10 is loaded in a piece of equipment provided with a voice output function, such as a TV set, DVD player, or the like.

Making explanation from upstream to downstream side, the acoustic signal processor 10 includes an acoustic signal input unit 12, an acoustic signal storage unit 14, an acoustic signal amplifier 16, and an acoustic signal output unit 18. Further, the acoustic signal processor 10 includes a voice detection unit 20 and a voice amplification calculation unit 22 as a path for acquiring an output of the acoustic signal storage unit 14 and amplifying the voice signal. In addition, the acoustic signal processor 10 includes an acoustic signal-to-loudness level transformation unit 24 and a threshold/level comparator 26 as a path for controlling the amplitude according to the loudness level. The aforementioned respective components can be implemented by, for example, a CPU, a memory, a program loaded in the memory, or the like, and here a configuration implemented by cooperation of these is depicted. Persons skilled in the art will understand that the function blocks can be implemented in various forms by means of only hardware, only software, or a combination of these.

Specifically, the acoustic signal input unit 12 acquires an input signal S_in of a sound for outputting it to the acoustic signal storage unit 14. The acoustic signal storage unit 14 stores, for example, 1024 samples (obtained in approx. 21.3 ms at a sampling frequency of 48 kHz) of the acoustic signal inputted from the acoustic signal input unit 12. A signal consisting of these 1024 samples is hereinafter referred to as a “1 frame”.

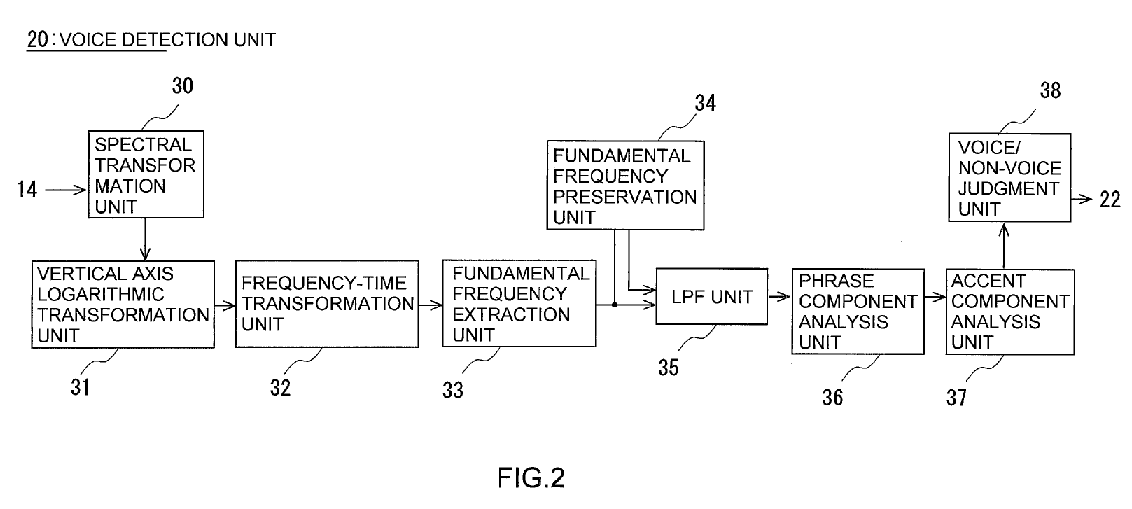

The voice detection unit 20 detects whether or not the acoustic signal buffered in the acoustic signal storage unit 14 is a speech or conversation. The configuration of the voice detection unit 20 and the processes executed thereby will be described later in FIG. 2.

If the voice detection unit 20 detects that the buffered acoustic signal is a speech or conversation, the voice amplification calculation unit 22 calculates a voice amplification amount in the direction of canceling the difference in level that has been calculated by the threshold/level comparator 26. If it is detected that the buffered acoustic signal is a non-conversation voice, the voice amplification calculation unit 22 determines that the voice amplification amount is to be equal to 0 dB, in other words, that the buffered acoustic signal is not to be amplified or dampened.

The acoustic signal-to-loudness level transformation unit 24 transforms the acoustic signal buffered in the acoustic signal storage unit 14 into a loudness level, which is a volume level actually perceived by a human. For this acoustic signal-to-loudness level transformation, the art disclosed in, for example, ITU-R (International Telecommunication Union Radiocommunications Sector) BS1770 can be utilized. More specifically, a characteristic curve given as a loudness level contour is inverted to calculate a loudness level. Therefore, in the present embodiment, the loudness level averaged over frames is used.

The threshold/level comparator 26 compares the calculated loudness level with a predetermined target level to calculate a difference in level.

The acoustic signal amplifier 16 invokes the acoustic signal buffered in the acoustic signal storage unit 14 to amplify or dampen it by the amount of amplification/attenuation calculated by the voice amplification calculation unit 22 for outputting it to the acoustic signal output unit 18. And, the acoustic signal output unit 18 outputs a gain-adjusted signal S_out to a speaker, or the like.

Next, the configuration of the voice detection unit 20 and the processes executed thereby will be described. FIG. 2 is a function block diagram illustrating a schematic configuration of the voice detection unit 20. In the voice discrimination processing which is applied in the present embodiment, the acoustic signal is divided into frames as defined above; the plural frames which are consecutive are frequency-analyzed; and it is judged whether the acoustic signal is of a conversation voice or of a non-conversation one.

And, in the voice discrimination processing, if the acoustic signal contains a phrase component or an accent component, it is judged that the acoustic signal is a voice signal. In other words, if it is detected that the later-described fundamental frequency for the frames is monotonously changed (monotonously increased or decreased), or is changed from a monotonous change into a constant frequency (in other words, is changed from a monotonous increase into a constant frequency, or from a monotonous decrease into a constant frequency), further or, is changed from a constant frequency into a monotonous change (in other words, is changed from a constant frequency into a monotonous increase, or from a constant frequency into a monotonous decrease), the aforementioned fundamental frequency being changed within a predetermined range of frequency, and the span of change of the aforementioned fundamental frequency being smaller than a predetermined span, the voice judgment processing judges the acoustic signal to be a voice.

The judgment that the acoustic signal is a voice is grounded on the following findings. In other words, in the case where the change of the aforementioned fundamental frequency is a monotonous change, it has been verified that there is a high possibility that the acoustic signal represents a phrase component of a human voice (a voice). In addition, in the case where the aforementioned fundamental frequency is changed from a monotonous change into a constant frequency, or in the case where the aforementioned fundamental frequency is changed from a constant frequency into a monotonous change, it has been verified that there is a high possibility that the acoustic signal represents an accent component of a human voice.

The band of the fundamental frequency of a human voice is generally between approx. 100 Hz to 400 Hz. More particularly, the fundamental frequency of a voice of a man is approx. 150 Hz±50 Hz, while the fundamental frequency of a voice of a woman is 250 Hz±50 Hz. Further, the fundamental frequency of a voice of a child is still higher than that of a woman, being approx. 300 Hz±50 Hz. Still further, in the case of a phrase component or accent component of a human voice, the span of change of the fundamental frequency is approx. 120 Hz.

In other words, if the aforementioned fundamental frequency is monotonously changed, or is changed from a monotonous change into a constant frequency, or is changed from a constant frequency into a monotonous change, the maximum value and the minimum value of the fundamental frequency being not within a predetermined range, the acoustic signal can be judged to be not a voice. In addition, if the aforementioned fundamental frequency is monotonously changed, or is changed from a monotonous change into a constant frequency, or is changed from a constant frequency into a monotonous change, the difference between the maximum value and the minimum value of the fundamental frequency being greater than a predetermined value, the acoustic signal can also be judged to be not a voice.

Therefore, if the aforementioned fundamental frequency is monotonously changed, or is changed from a monotonous change into a constant frequency, or is changed from a constant frequency into a monotonous change, the change of the fundamental frequency being within a predetermined range of frequency (the maximum value and the minimum value of the fundamental frequency being within a predetermined range), and the span of change of the fundamental frequency being smaller than a predetermined span of frequency (the difference between the maximum value and the minimum value of the fundamental frequency being smaller than a predetermined value), this voice discrimination processing can judge the acoustic signal to be a phrase component or an accent component. And yet, if the aforementioned predetermined range of frequency is set according to a voice of a man, that of a woman, or that of a child, the acoustic signal can be identified to be a voice of a man, that of a woman, or that of a child.

Thereby, the voice detection unit 20 in the acoustic signal processor 10 can detect a voice of a human with high accuracy, yet can detect both a voice of a man and that of a woman, and to a certain degree, can identify between a voice of a woman and that of a child.

Next, the configuration of the voice detection unit 20 for implementing the aforementioned voice discrimination processing will be specifically described with reference to FIG. 2. The voice detection unit 20 includes a spectral transformation unit 30, a vertical axis logarithmic transformation unit 31, a frequency-time transformation unit 32, a fundamental frequency extraction unit 33, a fundamental frequency preservation unit 34, an LPF unit 35, a phrase component analysis unit 36, an accent component analysis unit 37, and a voice/non-voice judgment unit 38.

The spectral transformation unit 30 performs FFT (Fast Fourier Transform) to the acoustic signal acquired from the acoustic signal storage unit 14 by the frame for transforming the voice signal in the time domain into data in the frequency domain (a spectrum). Prior to the FFT processing, in order to reduce errors in the frequency analysis, a window function, such as the Hanning window, may be applied to the acoustic signal divided into units of frames.

The vertical axis logarithmic transformation unit 31 transforms the frequency axis into the logarithm with base-10. The frequency-time transformation unit 32 performs an inverse 1024-point FFT to the spectrum logarithmically transformed by the vertical axis logarithmic transformation unit 31 for transforming it into data in the time domain. The transformed coefficients are referred to as the “cepstral” coefficients. And, the fundamental frequency extraction unit 33 determines the highest cepstral coefficient of the higher-order cepstral coefficients (approximately corresponding to the sampling frequency fs divided by 800 or greater), and the reciprocal number of the highest cepstral coefficient is defined as the fundamental frequency F0. The fundamental frequency preservation unit 34 preserves the calculated fundamental frequency F0. The subsequent processes use the fundamental frequency F0 by five frames, and thus it is necessary to preserve at least five frames.

The LPF unit 35 takes out the detected fundamental frequency F0 and the fundamental frequency F0 in the past from the fundamental frequency preservation unit 34 for low-pass filtering. By performing low-pass filtering, the noises on the fundamental frequency F0 can be filtered.

The phrase component analysis unit 36 analyzes whether the low-pass filtered fundamental frequency F0 in the past of five frames is monotonously increased or decreased, and if the frequency band width for the increase or decrease is within a predetermined value, for example, 120 Hz, it is judged that the fundamental frequency F0 is a phrase component.

The accent component analysis unit 37 analyzes whether the low-pass filtered fundamental frequency F0 in the past of five frames is changed from monotonous increase to flat (no change), or from flat to monotonous decrease, or remains flat, and if the frequency band width for the change is within 120 Hz, it is judged that the fundamental frequency F0 is an accent component.

If the accent component analysis unit 37 judges that the fundamental frequency F0 is the aforementioned phrase component or accent component, the voice/non-voice judgment unit 38 judges that a voice scene is given, and if either of the aforementioned requirements is not met, it judges that a non-voice scene is given.

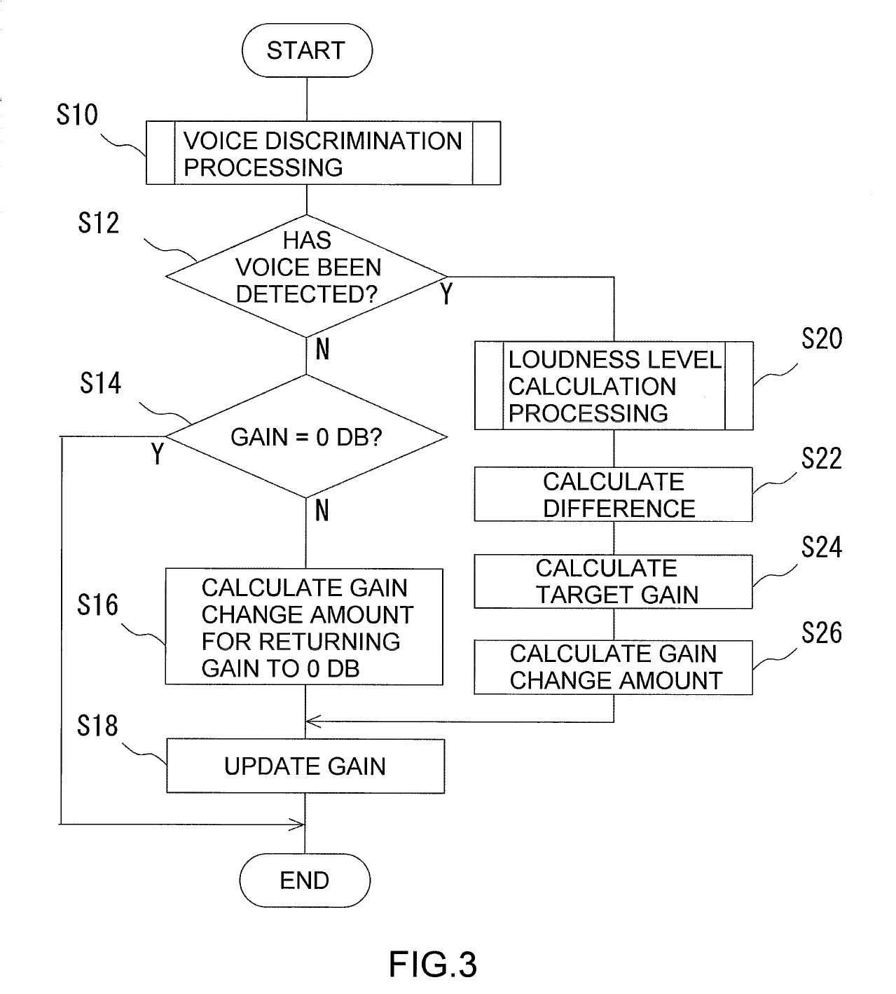

The operation of the acoustic signal processor 10 which is configured as above will be described. FIG. 3 is a flow chart illustrating the operation of the acoustic signal processor 10.

An acoustic signal inputted into the acoustic signal input unit 12 of the acoustic signal processor 10 is buffered in the acoustic signal storage unit 14, and the voice detection unit 20 executes the aforementioned voice discrimination processing for discriminating whether or not the buffered acoustic signal contains a voice (S10). In other words, the voice detection unit 20 analyzes the data of a predetermined number of frames as described above to judge whether a voice scene or a non-voice scene is given.

Next, if any voice is not detected (N at S12), the voice amplification calculation unit 22 checks whether or not the currently set gain is 0 dB (S14). If the gain is 0 dB (Y at S14), the processing by the pertinent flow is terminated, and for the subsequent frames, the processing is again executed from S10. If the gain is not 0 dB (N at S14), the voice amplification calculation unit 22 calculates a gain change amount for each one sample for returning the gain to 0 dB in a predetermined release time (S16). The calculated gain change amount is notified to the acoustic signal amplifier 16, and the acoustic signal amplifier 16 reflects that gain change amount to the set gain to update the gain (S18). Thereby, the processing when a non-voice scene is given and the set gain is not 0 dB is terminated.

If the process at S12 determines that a voice has been detected (Y at S12), the acoustic signal-to-loudness level transformation unit 24 calculates a loudness level (S20). Next, the threshold/level comparator 26 calculates a difference from a predetermined target level of voice (S22). Next, the voice amplification calculation unit 22 calculates a gain amount to be actually reflected (a target gain) in accordance with the calculated difference and a predetermined ratio (S24). The aforementioned ratio sets the degree to which the calculated difference is reflected to the gain change amount subsequently described. And, the voice amplification calculation unit 22 calculates a gain change amount from the current target gain in accordance with the attack time which is set (S26). Next, the acoustic signal amplifier 16 updates the gain, using the gain change amount calculated by the voice amplification calculation unit 22 (S18).

According to the above-described configuration and processing, in the case where the acoustic signal contains a voice (a human voice), by performing amplification processing on the basis of a loudness level, which is a volume level actually perceived by a human, a conversation, and the like, in a content can be made easy to be listened. In addition, because there is no need for making a volume control operation, the audience will not be disturbed upon hearing the content. In other words, by adjusting the input signal such that the sound volume of the conversation or speech in the content is constant, the audience can be alleviated from a burden of making a volume control operation.

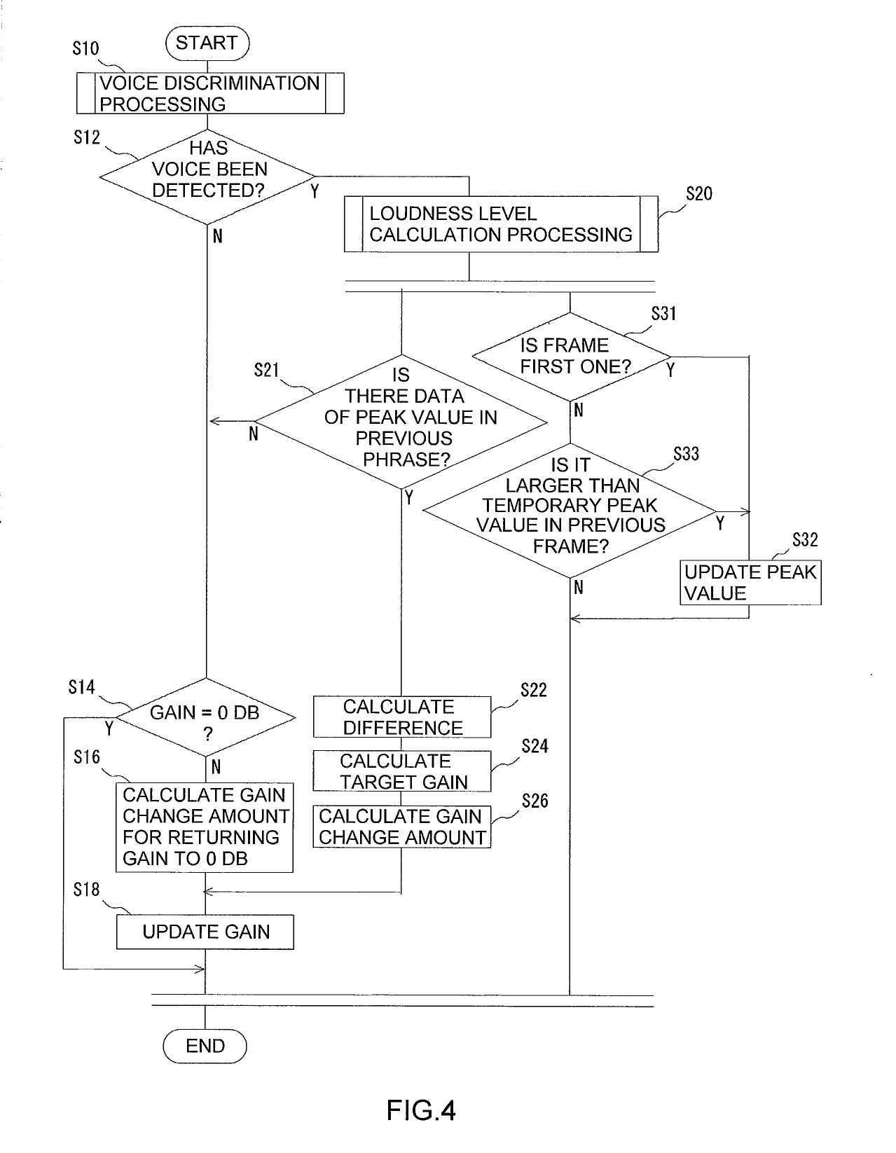

Next, a first modification of the process illustrated using the flow chart in FIG. 3 will be described with reference to the flow chart in FIG. 4. In this first modification, following the loudness level calculation processing (S20) in the above-described processing, a first chain of processes (S21 to S26) for calculating a gain change amount and a second chain of processes (S31 to S33) for calculating a peak value are executed as parallel processing.

Here, the phrase refers to a period from the moment when a voice has been detected to that when it has not been detected. And, in the present modification, the voice amplification calculation unit 22 detects a peak value of loudness level in each phrase rather than the average loudness level over the frames; calculates the difference between the current target level and the peak value of loudness level in the previous phrase; and calculates a target gain in accordance with the difference. For the same processes as those in the flow chart in FIG. 3, the description thereof will be simplified.

If the voice detection unit 20 executes the voice discrimination processing (S10), and has detected no voice (N at S12), as described above, the process of checking the gain (S14); the process of calculating a gain change amount (S16) if the gain is not 0 dB (N at S14); and the process of reflecting the gain change amount to the set gain for updating the gain (S18) are executed.

If a voice is detected (Y at S12), the program proceeds to the process of detecting a peak level value in the phrase. First, the loudness level calculation processing (S20) is executed. In the voice discrimination processing at S10, a section in which a voice has been detected is stored in a predetermined storage area (such as the acoustic signal storage unit 14, the working storage area not shown, or the like), being associated with the acoustic signal stored in the acoustic signal storage unit 14. In other words, in the voice discrimination processing at S10, the phrase is identified. The acoustic signal-to-loudness level transformation unit 24 calculates a peak value of loudness level in the phrase.

Next, a first chain of processes for calculating a gain change amount (S21 to S26) and a second chain of processes for calculating a peak value (S31 to S33) are executed as parallel processing. First, in the first chain of processes (S21 to S26), the threshold/level comparator 26 checks whether or not there exists data of the peak value in the previous phrase (S21). If no peak value exists (N at S21), the program proceeds to the aforementioned S14, and then the subsequent processes. In the present modification, it is assumed that, for example, when the program is changed over in a TV set, or a new content is reproduced in a DVD player, the variables, such as the peak value, and the like, are initialized. Accordingly, when a content is newly reproduced, there exists no peak value.

If there is data of the peak value in the previous phrase (Y at S21), the voice amplification calculation unit 22 calculates the difference between a predetermined target level and the peak value in the previous phrase (S22); calculates a target gain in accordance with the set ratio (S24); and further, in accordance with the set attack time, calculates a gain change amount for each one sample (S26). And the acoustic signal amplifier 16 updates the gain in accordance with the calculated gain change amount (S18). Thereby, the first chain of processes is terminated.

On the other hand, in a second chain of processes (S31 to S33), which is the other of the parallel processing chains, the threshold/level comparator 26 checks whether or not the frame is a first one in the phrase (S31). If the frame is a first one in the phrase (Y at S31), the calculated loudness level is defined as the initial peak value in the phrase, and the peak value is updated (S32). If the frame is not a first one in the phrase (N at S31), the threshold/level comparator 26 compares the calculated loudness level with the temporary peak value up to the previous frame (S33). If the calculated loudness level is larger than the temporary peak value up to the previous frame (Y at S33), the calculated loudness level is defined as the temporary peak value up to the current frame, and the peak value is updated (S32), and if the calculated loudness level is not more than the temporary peak value up to the previous frame (N at S33), the process will be terminated without the peak value being updated.

As described above, according to the present modification, the same advantages as those in the aforementioned embodiment can be implemented. Further, the system is configured such that the difference from the target level is reflected by the phrase, whereby occurrence of an output fluctuation associated with the gain control can be avoided. Then, the audience is capable of listening with no sense of incongruity without being aware of the gain control being made. In the case where the acoustic signal processor 10 has a sufficiently high processing speed, or in the case where the lapse of processing time to the final signal output is not critical, the peak value in the current phrase may be used without using the peak value in the last phrase . However, from the viewpoint of averaging the loudness level between contents, even if the peak value in the last phrase is used, sufficient advantages can be obtained.

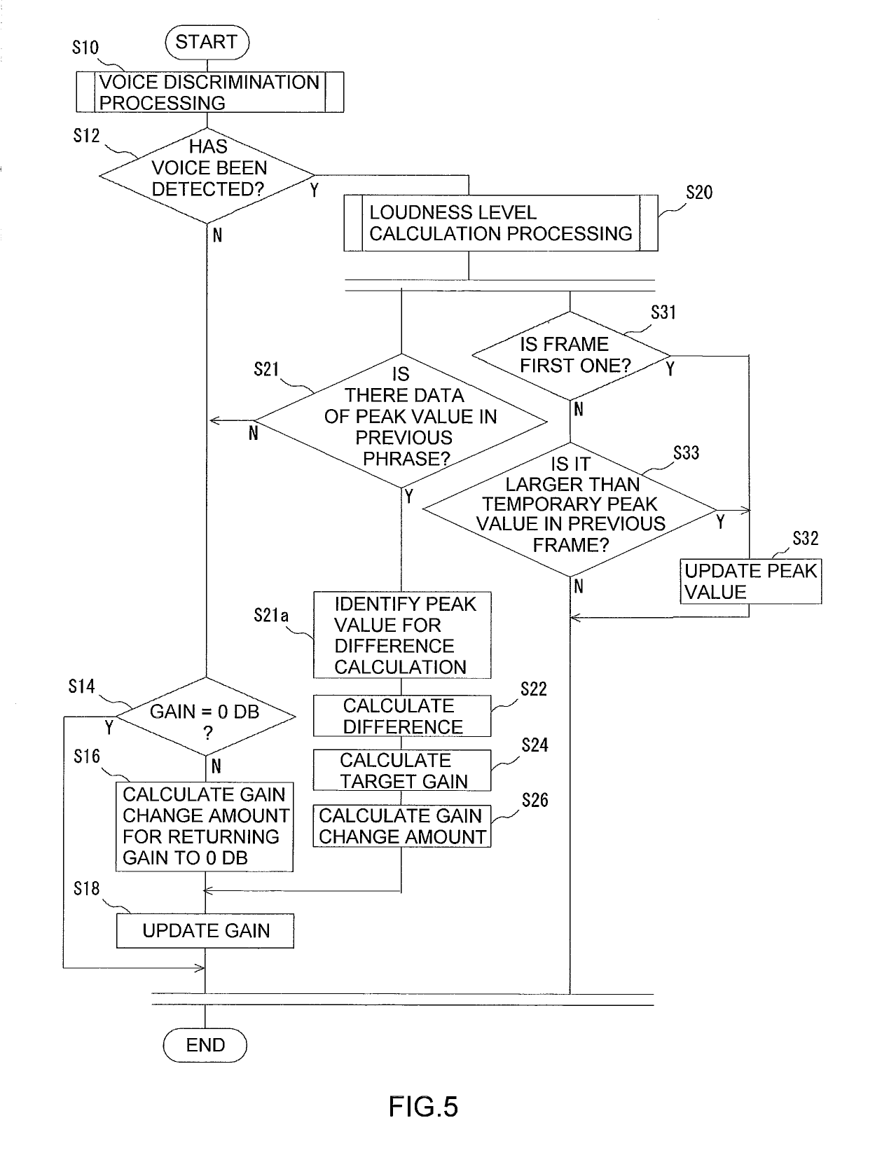

Next, a second modification will be described with reference to the flow chart in FIG. 5. In the first modification, if a voice has been detected, the peak value in the previous phrase has been used for calculating an amplification amount. However, in the second modification, if the temporary peak value in the current phrase exceeds the peak value in the previous phrase, the amplification amount is calculated on the basis of the temporary peak value in the current phrase. For the same processes as those in the flow chart in FIG. 4, the description thereof will be simplified.

First, if the voice detection unit 20 executes the voice discrimination process (S10), and has detected no voice (N at S12), the process of checking the gain (S14); the process of calculating a gain change amount (S16) if the gain is not 0 dB (N at S14); and the process of reflecting the gain change amount to the set gain for updating the gain (S18) are executed.

If a voice is detected (Y at S12), the program proceeds to the process of detecting a peak level value in the phrase. First, the loudness level calculation processing (S20) is executed. Then, by parallel processing, a first chain of processes for calculating a gain change amount (S21 to S26) and a second chain of processes for calculating a peak value (S31 to S33) are executed.

First, in the first chain of processes (S21 to S26), the threshold/level comparator 26 checks whether or not there exists data of the peak value in the previous phrase (S21). If no peak value exists (N at S21), the program proceeds to the processes starting at the aforementioned S14.

If there exists data of the peak value in the previous phrase (Y at S21), the peak value to be used in the process of difference calculation at S22 is identified (S21a) prior to the process at S22 being started. Specifically, the threshold/level comparator 26 compares the peak value up to the previous phrase (hereinafter to be referred to as the “old peak value”) with the peak value in the current phrase (hereinafter to be referred to as the “new peak value”), and if the old peak value is greater than the new peak value, the old peak value is selected as the peak value to be used in the process of difference calculation, while, if the old peak value is not more than the new peak value, the new peak value is selected as the peak value to be used in the process of difference calculation. Then, the voice amplification calculation unit 22 calculates the difference between a predetermined target level and the peak value identified in the process at S21a (S22); calculates a target gain in accordance with the set ratio (S24); and further calculates a gain change amount for each one sample in accordance with the set attack time (S26). And, the acoustic signal amplifier 16 updates the gain to the calculated gain change amount (S18).

In addition, in the second chain of processes (S31 to S33), which constitutes the other of the parallel processing chains, the process of checking whether the frame is a first one in the phrase (S31); the process of updating the peak value (S32); and the process of comparing the calculated loudness level with the temporary peak value up to the previous frame (S33) are executed in the same way as in the first modification.

Thus, in the second modification, an unnecessary amplification can be avoided in the case where the peak value in the current phrase is larger than the peak value in the previous phrase.

Hereinabove, the present invention has been described on the basis of the embodiment. This embodiment provides only an exemplification, and any person with an ordinary skill in the art could understand that, by combining the components thereof, various modifications can be created, and such modifications are within the scope of the present invention.

### Description of Symbols

10: Acoustic signal processor

12: Acoustic signal input unit

14: Acoustic signal storage unit

16: Acoustic signal amplifier

18: Acoustic signal output unit

20: Voice detection unit

22: Voice amplification calculation unit

24: Acoustic signal-to-loudness level transformation unit

26: Threshold/level comparator

30: Spectral transformation unit

31: Vertical axis logarithmic transformation unit

32: Frequency-time transformation unit

33: Fundamental frequency extraction unit

34: Fundamental frequency preservation unit

35: LPF unit

36: Phrase component analysis unit

37: Accent component analysis unit

38: Voice/non-voice judgment unit

1. A gain control apparatus, comprising:
a voice detection unit which detects a voice section from an acoustic signal,
an acoustic signal-to-loudness level transformation unit which calculates a loudness level, which is a volume level actually perceived by a human, for the acoustic signal,
a level comparison unit which compares the calculated loudness level with a predetermined target level,
an amplification amount calculation unit which calculates a gain control amount for the acoustic signal on the basis of the detection result by the voice detection unit and the comparison result by the level comparison unit, and
a voice amplification unit which makes a gain adjustment of the acoustic signal in accordance with the gain control amount calculated.

2. The gain control apparatus according to claim 1, wherein the acoustic signal-to-loudness level transformation unit calculates a loudness level, upon the voice detection unit having detected a voice section.

3. The gain control apparatus according to claim 1 or 2, wherein the acoustic signal-to-loudness level transformation unit calculates a loudness level by the frame which is constituted by a predetermined number of samples.

4. The gain control apparatus according to claim 1 or 2, wherein the acoustic signal-to-loudness level transformation unit calculates a loudness level by the phrase, which is a unit of voice section.

5. The gain control apparatus according to claim 4, wherein
the acoustic signal-to-loudness level transformation unit calculates a peak value of loudness level by the phrase, and
the level comparison unit compares the peak value of loudness level with the predetermined target level.

6. The gain control apparatus according to claim 5, wherein
upon the peak value of loudness level in the current phrase exceeding the peak value of loudness level in the previous phrase, the level comparison unit compares the peak value of loudness level in the current phrase with the predetermined target level, and
upon the peak value of loudness level in the current phrase being not more than the peak value of loudness level in the previous phrase, the level comparison unit compares the peak value of loudness level in the previous phrase with the predetermined target level.

7. The gain control apparatus according to claim 1, wherein the voice detection unit comprises:
a fundamental frequency extraction unit which extracts a fundamental frequency from the acoustic signal for each frame,
a fundamental frequency change detection unit which detects a change of the fundamental frequency in a predetermined number of plural frames which are consecutive, and
a voice judgment unit which judges the acoustic signal to be a voice, upon the fundamental frequency change detection unit detecting that the fundamental frequency is monotonously changed, or is changed from a monotonous change to a constant frequency, or is changed from a constant frequency to a monotonous change, the fundamental frequency being changed within a predetermined range of frequency, and the span of change of the fundamental frequency being smaller than a predetermined span of frequency.

8. A gain control method, comprising:
a voice detection step of detecting a voice section from an acoustic signal buffered for a predetermined period of time,
an acoustic signal-to-loudness level transformation step of calculating a loudness level, which is a volume level actually perceived by a human, from the acoustic signal,
a level comparison step of comparing the calculated loudness level with a predetermined target level,
an amplification amount calculation step of calculating a gain control amount for the acoustic signal being buffered, on the basis of the detection result by the voice detection step and the comparison result by the level comparison step, and
a voice amplification unit which performs a gain adjustment to the acoustic signal in accordance with the gain control amount calculated.

9. The gain control method according to claim 8, wherein the acoustic signal-to-loudness level transformation step calculates a loudness level, upon the voice detection step having detected a voice section.

10. The gain control method according to claim 8 or 9, wherein the acoustic signal-to-loudness level transformation step calculates a loudness level by the frame which is constituted by a predetermined number of samples.

11. The gain control method according to claim 8 or 9, wherein the acoustic signal-to-loudness level transformation step calculates a loudness level by the phrase, which is a unit of voice section.

12. The gain control method according to claim 11, wherein the acoustic signal-to-loudness level transformation step calculates a peak value of loudness level by the phrase, and
the level comparison step compares the peak value of loudness level with the predetermined target level.

13. The gain control method according to claim 12, wherein
the level comparison step compares the peak value of loudness level in the current phrase with the predetermined target level, upon the peak value of loudness level of the current phrase exceeding the peak value of loudness level in the previous phrase, and
the level comparison step compares the peak value of loudness level in the previous phrase with the predetermined target level, upon the peak value of loudness level in the current phrase being not more than the peak value of loudness level in the previous phrase.

14. The gain control method according to claim 8, wherein the voice detection step comprises:
a fundamental frequency extraction step of extracting a fundamental frequency from the acoustic signal for each frame,
a fundamental frequency change detection step of detecting a change of the fundamental frequency in a predetermined number of plural frames which are consecutive, and
a voice judgment step of judging the acoustic signal to be a voice, upon the fundamental frequency change detection step detecting that the fundamental frequency is monotonously changed, or is changed from a monotonous change to a constant frequency, or is changed from a constant frequency to a monotonous change, the fundamental frequency being changed within a predetermined range of frequency, and the span of change of the fundamental frequency being smaller than a predetermined span of frequency.

15. A voice output apparatus, comprising the gain control apparatus according to claim 1.
